(19) United States
(12) Patent Application Publication
(10) Pub. No.: US 2025/0078039 A1
(43) Pub. Date: Mar. 6, 2025

(54) SYSTEM FOR MONITORING AND FACILITATING MATTRESS CARE

(71) Applicants: Mark Lustbader, Davie, FL (US); Steve Gelley, Davie, FL (US); Tim Sloan, Davie, FL (US); James Murphy, Davie, FL (US); Chris Edwards, Davie, FL (US); Yih-Shyang Tsai, Davie, FL (US)

(72) Inventors: Mark Lustbader, Davie, FL (US); Steve Gelley, Davie, FL (US); Tim Sloan, Davie, FL (US); James Murphy, Davie, FL (US); Chris Edwards, Davie, FL (US); Yih-Shyang Tsai, Davie, FL (US)

(21) Appl. No.: 18/240,204

(22) Filed: Aug. 30, 2023

(51) Int. Cl. G06Q 10/20

(52) U.S. Cl. CPC G06Q 10/20

(57) ABSTRACT

The embodiments described herein generally relate to a business-to-business or business-to-consumer software-as-a-service platform configured for monitoring and maintaining mattress health in a residential or commercial setting. The SaaS platform may be in operable communication with at least one sensor specifically associated with a mattress. Sensors may include temperature sensors, moisture sensors, gyroscopic sensors, soil sensors, and the like. A smart device, such as a smartphone, may also be in communication with the sensor via a computer program product executed by a processor on the smart device or on a server-based platform. The system may be configured to monitor and track mattress health overtime and provide notifications and instructions on when maintenance is required and performed correctly.

### CROSS-REFERENCE TO RELATED APPLICATIONS

This application claims the benefit of U.S. Provisional Application No. 63/3,442,680 filed Feb. 1, 2023.

### TECHNICAL FIELD

The embodiments generally relate to computerized systems and accompanying hardware for monitoring mattress health and facilitating mattress care.

### BACKGROUND

Typical mattress lifespan ranges from 7-10 years, with many factors influencing how long a mattress actually lasts, including the quality of materials, the weight and habits of users, and how the mattress should be cared for. Materials like latex or high-density foam last longer while low-density foam can be worn quickly.

Mattresses are not commonly cared for according to manufacturer or retailer instruction. Most commonly, mattresses are not flipped or rotated according to recommended specifications. As a result, the vast majority of mattresses will deteriorate, sag, and get depressions, indentations, and odors over time.

Other materials and constructions, such as springs, fabrics, foams, hybrid constructions, pillow tops, and air bladder mattresses suffer similar loss of quality over time.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments generally relate to a business-to-business (B2B), or business-to-consumer (B2C) software-as-a-service (SaaS) platform configured for monitoring and maintaining mattress health in a residential or commercial setting.

The embodiments generally relate to a SaaS platform in operable communication with at least one sensor specifically associated with a mattress. According to some embodiments, the sensor may be a sensor suite including a plurality of various sensors. Sensors may include temperature sensors, moisture sensors, gyroscopic sensors, soil sensors, and the like. A smart device, such as a smartphone, may also be in communication with the sensor via a computer program product executed by a processor on the smart device or on a server-based platform. The platform may be configured to receive information identifying a mattress and a mattress maintenance interval from the sensor. The sensor may be configured to monitor, track, and communicate mattress maintenance interval data such as, but not limited to, age, X, Y, or Z-axis orientation, number of rotations, number of times the mattress has been flipped, or the like to the SaaS platform.

In response to determining that the mattress maintenance interval has elapsed, an alert is communicated over a network to the SaaS platform and computer program product. Mattress maintenance interval data is received from the orientation sensor, and the system determines whether mattress maintenance has been performed correctly based on the orientation data. In response to determining that mattress maintenance has been correctly performed, mattress maintenance data is updated and stored. Alternatively, mattress data may indicate that mattress maintenance is required, and the system may communicate a notification, over a network, to any number of smart devices to alert a residential user's device or a number of commercial users' devices to indicate required maintenance.

Both the foregoing general description and the following detailed description present embodiments intended to provide an overview or framework for understanding the nature and character of the embodiments disclosed herein. Any accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a diagram of a system for monitoring and facilitating mattress care, according to some embodiments;

FIG. 4 illustrates a flowchart for use of a system for monitoring and facilitating mattress care, according to some embodiments; and

FIG. 4 illustrates a flowchart of the execution of a system for monitoring and facilitating mattress care, according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

As used herein, the term “user” may be utilized to relate to any user of the system including individuals accessing the system, such as individual residential users and commercial application users. “User” may also refer to administrator users and the like.

The embodiments generally relate to a business-to-business (B2B), or business-to-consumer (B2C) software-as-a-service (SaaS) system configured for monitoring and maintaining mattress health in a residential or commercial setting. The system may be configured for monitoring the health of mattress(es) over time. The system may include a hardware suite including a sensor suite configured to monitor, track, and communicate mattress maintenance interval data such as, but not limited to, age, X-axis, Y-axis, or Z-axis orientation, number of rotations, number of times the mattress has been flipped, frequency of mattress rotations or flips, moisture levels, mattress compression, odor, soil levels, or the like.

The hardware suite may include a housing constructed and arranged to enclose the sensor suite. The hardware suite may be an industrially engineered form of various sizes or shapes. The hardware suite may be attached to the exterior of a mattress, such as within the mattress label or tag. The hardware suite may be attached to the exterior surface of the mattress by sewing, Velcro, glue or other method. It may also be put inside or onto the mattress by manufacturers. Alternatively, the hardware suite may be embedded within a mattress. The means of attachment may be semi-permanent and may allow for temporary removal and reattachment of the hardware suite. The hardware suite may include an onboard processor, memory, battery, and the like to facilitate support of the sensor suite.

The sensor suite may include positional sensors, temperature sensors, moisture sensors, or the like for monitoring, storing as data, and communicating to the system mattress maintenance interval data such as, but not limited to, age, X-axis, Y-axis, or Z-axis orientation, number of rotations, number of times the mattress has been flipped, frequency of mattress rotations or flips, moisture levels, mattress compression, odor, soil levels, or the like.

In response to determining that the mattress maintenance interval has elapsed, an alert is communicated from the sensor suite over a network to the SaaS platform and computer program product installed on a user device. Alternatively, the SaaS platform may be configured to communicate an inquiry from the system to the sensor suite to determine if a mattress maintenance interval has elapsed, and an alert is communicated from the sensor suite over a network to the SaaS platform and computer program product installed on a user device.

Upon receiving an alert, action may be taken by a user to perform the required maintenance such as flipping or rotating a mattress. The system may be configured to communicate and display the required maintenance on a display of a smart device. A user may input maintenance performance after a mattress has been flipped, rotated, or the like. In response to determining that mattress maintenance has been correctly performed, mattress maintenance data is updated and stored by the system. Alternatively, mattress data may indicate that mattress maintenance is required, and the system may communicate a notification, over a network, to any number of smart devices to alert a residential user's device or a number of commercial users' devices to indicate required maintenance. In this way, the system may be configured to facilitate extending mattress life and user understanding of mattress maintenance requirements to create value for consumers, prevent unnecessary sagging, depressions, and breakdowns within a mattress as well as prevent potential medical issues and promote better sleep.

As a non-limiting example, the system may be implemented in a residential setting to monitor mattress health of a single user's mattress. A user may install a mobile application version of the system on a smart device and utilize near-field communication technology, such as Wi-Fi, Bluetooth, Z-Wave, RFID, or the like to link the hardware and sensor suite attached to the mattress to the mobile application version of the system on the smart device. The system may be configured to allow a user to name the mattress, enter manufacturer or purchase details, purchase date, and the like. The system may be configured to collect user name, mattress location, address, communication details, and name of the room in which the mattress is located. Similarly, mattress brand, type, and age may be entered into the system. The system may be configured to retrieve mattress data from a database stored on a network relating to mattress life expectancy and required maintenance based on brand, make, year, and the like. Routinely, the system may notify the users smart device or required maintenance, provide instruction on how to perform the required maintenance via the smart device, receive user input that the required maintenance has been completed, and updating the system with mattress maintenance interval data.

The system may also be configured to monitor that correct maintenance has been performed. The system may determine mattress orientation prior to maintenance and after maintenance to determine if maintenance has been performed correctly. As an example, the system may utilize the sensor suite to determine X-axis, Y-axis, or Z-axis orientation and determine that the mattress requires flipping the mattress on the Z-axis. By monitoring positional data via the sensor suite, the system may be configured to determine that the mattress has been incorrectly flipped on the X-axis or Y-axis. Upon such an occurrence, the system may provide a notification via the user's smart device that incorrect maintenance has occurred. The system may display, on the user device, how to perform the correct maintenance to flip the mattress along its Z-axis. Upon completion of correct maintenance, the system may reset the maintenance interval.

According to some embodiments, performing routine maintenance on a mattress may be gamified via the system by introducing scoring systems, points, displayed applause or confetti, or the like based on frequency of completing mattress maintenance.

The system may also include use your help functionality and may provide a means to communicate with service providers in order to perform required maintenance, the system may also be configured to recommend mattress disposal options, recycling options, and donation options where the system has determined that a mattress' lifespan is ending or has ended.

Similarly, in an example commercial setting the system may be configured to monitor mattress health of a plurality of matrices, such as in a hotel, cruise ship, or housing setting. Routinely, the system may notify hotel staff users smart devices of required maintenance, provide instruction on how to perform the required maintenance via the smart device, receive hotel staff user input that the required maintenance has been completed, and updating the system with mattress maintenance interval data.

The system may be configured to store mattress data based on a number of factors including, but not limited to, mattress manufacturer, brand, model, life expectancy, and the like. Stored mattress data may be linked to received user data to profile user purchases and user preferences. In this way, user and mattress data may be invaluable to sleep product manufacturers.

The system may be configured to store and monitor mattress warranty information, including warranty verification or extension.

The system may be configured to integrate, via API, with commercial property management systems and communicate with commercial property management systems over a local network, including integration with internet-of-things (IoT) devices such as smart locks, smart TV's, smart thermostats, and the like.

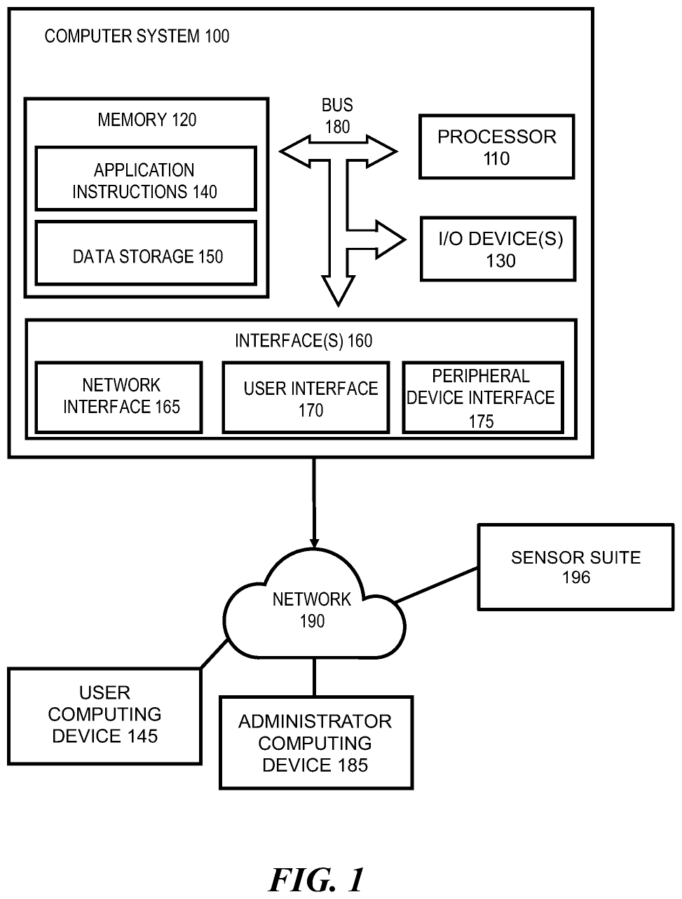

FIG. 1 illustrates an example of a computer system 100 that may be utilized to execute various procedures, including the processes described herein. Computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the actions and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. The computer system 100 may be in operable communication with the sensor suite 196 over the network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized to establish credentials, create a user profile, and otherwise interact with the various property management and real estate investment functionalities of the system. The third-party computing device 195 may be utilized by third parties to receive communications from the user computing device and/or administrative computing device 185.

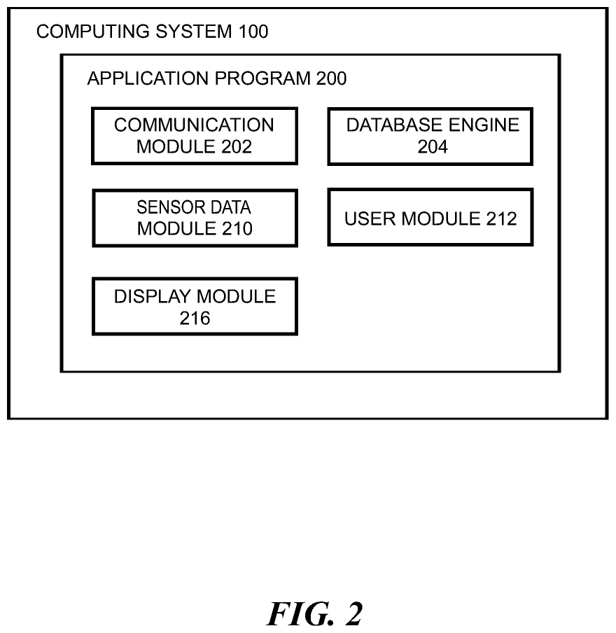

FIG. 2 illustrates an example computer architecture for the application program 200 operated via the computing system 100. Computer system 100 comprises several modules and engines configured to execute the functionalities of the application program 200, and a database engine 204 configured to facilitate how data is stored and managed in one or more databases, such as cloud-based storage. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a sensor data module 210, a user module 212, and a display module 216.

In some embodiments, the communication module 202 is configured for receiving, processing, and transmitting a user command and/or user input. In such embodiments, the communication module 202 performs communication functions between various devices, including a user computing device 145, an administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system. The communication module 202 is operable to transmit alerts and notifications to secondary user devices as described hereinabove.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases, including mattress maintenance data.

In some embodiments, the sensor data module 210 is configured to selectively monitor, receive, store via the database engine 204, and communicate via the communication module 202 sensor data collected from the sensor suite by the system. The sensor data module 210 may be configured to systematically and routinely compare mattress maintenance data to measured sensor suite data to determine if maintenance is required and if a notification should be communicated to a user device that mattress maintenance is required.

In some embodiments, the user module 212 facilitates the creation of a user account for the application system. The user module 212 may allow the user to input account information, user preferences, mattress data, and the like. User accounts may upload, download, and otherwise store data on the system and tag data or other users with respect to the sensor data module 210.

In some embodiments, the display module 214 is configured to display one or more GUIs, including, e.g., one or more user interfaces or one or more consumer interfaces. In some embodiments, the display module 214 is configured to temporarily generate and display various pieces of information in response to one or more commands or operations, such as the maintenance notifications or confirmation of upload or download of data The display module 214 may be configured to display notifications via the user's smart device that mattress maintenance is required, maintenance is complete, incorrect maintenance has occurred, instructions on proper maintenance, and the like. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed via the display module 214 may not be persistently stored.

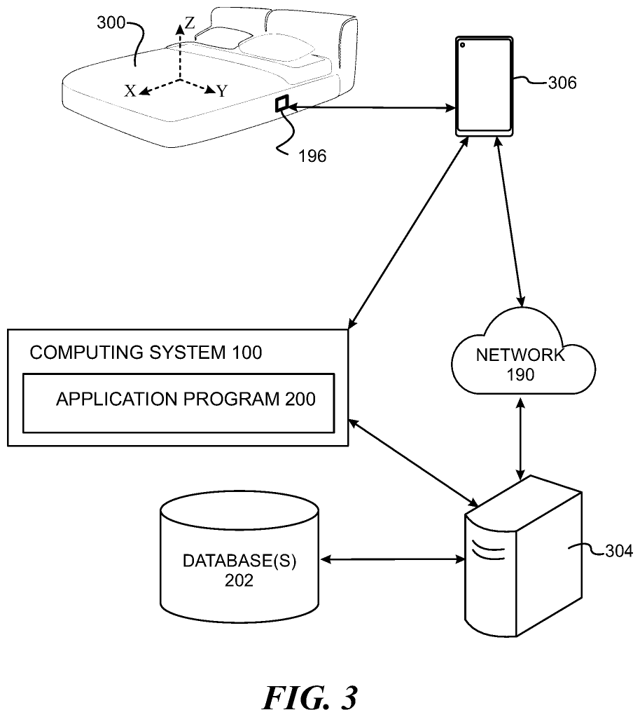

Referring to FIG. 3, the system may be configured to monitor sensor suite 196 data (attached to mattress 300) via a user smart device 306 in operable communication with a computing system 100 and application program 200. According to some embodiments, the application program 100 and some of its aspects and functionality may be executable by, or executed on, any of the user smart device 306, computing system 100, or server system 304, or combinations of the three, in operable connection over a network 190.

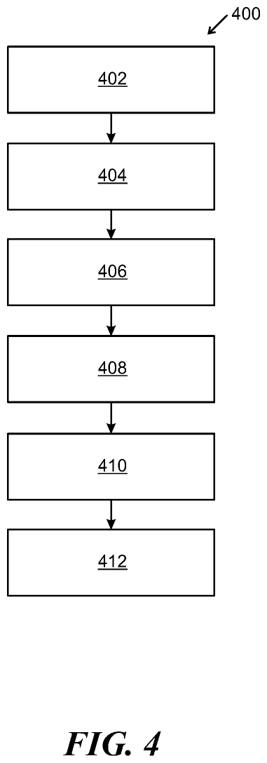

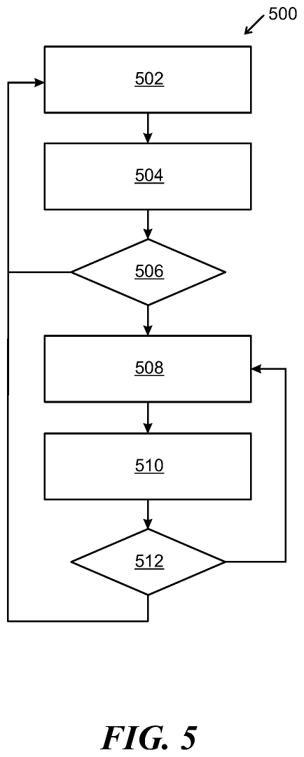

Referring to FIG. 4, an exemplary flowchart 400 depicts how a user may interact with the system. In action 402, a user may install the application program on a smart device. In action 404, the user may utilize the application program to link a sensor suite to the application program, and submit user data, mattress data, and the like. In action 406, the system may monitor sensor suite data over time, either continuously or routinely. If the system determines that sensor data indicates mattress maintenance is required, in action 408, the system may communicate a notification or alert to the user smart device indicating that maintenance is required. In action 410, the user may perform the indicated maintenance and provide input to the system indicating that maintenance has occurred. In action 412, the system may communicate with the sensor suite to determine that maintenance has occurred properly and, if true, reset the relevant maintenance interval.

Referring to FIG. 4, an exemplary flowchart 500 depicts how the system may monitor mattress health over time by comparing real time mattress data to predetermined maintenance intervals. In action 502, the system may be in a monitoring state collecting various mattress data such as mattress orientation, temperature, soil level, moisture level, or the like via the integrated sensor suite. In action 504, the system may interact with the application instructions on any of the user smart device 306, computing system 100, or server system 304 and database 202 (as in FIG. 4) to retrieve or read mattress maintenance interval data based on the desired mattress, make, model, and the like. In action 506, the system may compare collected mattress data to mattress maintenance interval data to determine if mattress maintenance is required. If no maintenance is required, the system may revert to action 502. If maintenance is determined to be required, the system may generate and communicate a notification to a user device in action 508. In action 510, the system may receive user maintenance action input relating to the required maintenance. In action 512, the system may compare the user maintenance action input to the required maintenance to confirm that the proper maintenance has been accomplished. If maintenance has been improperly performed, the system may revert to action 508 and re-communicate the need for maintenance, and where appropriate, provide updated instructions on how to perform maintenance. If maintenance has been properly performed, the system may revert to action 502.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a system for monitoring and facilitating mattress care, the system may include at least one computing device in operable connection with a network; a memory that stores computer-executable components; a processor that executes the computer-executable components stored in the memory, wherein the computer-executable components include instructions for: collecting mattress data via a sensor suite; reading mattress maintenance interval data from a database in operable communication with the at least one computing device; compare mattress data to mattress maintenance interval data to determine if mattress maintenance is required; communicating at least one notification to the at least one computing device that maintenance is required; receiving user input via the at least one computing device that maintenance has been performed; collecting mattress data via the sensor suite; and determining that maintenance has been properly performed.

Variation 2 may include a system for monitoring and facilitating mattress care as in variation 1, wherein determining that maintenance has been properly performed includes communicating a notification to the at least one computing device that maintenance is complete.

Variation 3 may include a system for monitoring and facilitating mattress care as in variations 1 or 2, wherein determining that maintenance has been properly performed includes communicating a notification to the at least one computing device that maintenance is incomplete.

Variation 4 may include a system for monitoring and facilitating mattress care as in any of variations 1 through 3, further including communicating instructions on how to properly perform maintenance to the at least one computing device.

Variation 5 may include a system for monitoring and facilitating mattress care as in any of variations 1 through 4, further including displaying the instructions on how to properly perform maintenance on the at least one computing device.

Variation 6 may include a system for monitoring and facilitating mattress care as in any of variations 1 through 5, wherein the sensor suite is integrated into a mattress.

Variation 7 may include a system for monitoring and facilitating mattress care as in any of variations 1 through 6, wherein mattress data includes at least one of mattress orientation, temperature, soil level, or moisture level.

Variation 8 may include a system for monitoring and facilitating mattress care as in any of variations 1 through 3, wherein the sensor suite includes at least one of a temperature sensor, moisture sensor, gyroscopic sensor, or soil sensor.

According to variation 9, a non-transitory computer-readable media maintaining instructions of a first instance of an application that, when executed by one or more processors of a first computing device, program the one or more processors to collect first mattress data via a sensor suite; read mattress maintenance interval data from a database in operable communication with the at least one computing device; compare mattress data to mattress maintenance interval data to determine if mattress maintenance is required; communicate at least one notification to the at least one computing device that maintenance is required; receive user input via the at least one computing device that maintenance has been performed; collect second mattress data via the sensor suite; and determine that maintenance has been properly performed by comparing the second mattress data to the first mattress data and the mattress maintenance interval data.

Variation 10 may include a system for monitoring and facilitating mattress care as in variation 9, wherein determining that maintenance has been properly performed includes communicating a notification to the at least one computing device that maintenance is complete.

Variation 11 may include a system for monitoring and facilitating mattress care as in variations 9 or 10, wherein determining that maintenance has been properly performed includes communicating a notification to the at least one computing device that maintenance is incomplete.

Variation 12 may include a system for monitoring and facilitating mattress care as in any of variations 9 through 11, further including communicating instructions on how to properly perform maintenance to the at least one computing device.

Variation 13 may include a system for monitoring and facilitating mattress care as in any of variations 9 through 12, further including displaying the instructions on how to properly perform maintenance on the at least one computing device.

Variation 14 may include a system for monitoring and facilitating mattress care as in any of variations 9 through 13, wherein the sensor suite is at least one of sewn, glued, or adhered to a mattress.

Variation 15 may include a system for monitoring and facilitating mattress care as in any of variations 9 through 14, wherein mattress data includes at least one of mattress orientation, temperature, soil level, or moisture level.

Variation 16 may include a system for monitoring and facilitating mattress care as in any of variations 9 through 15, wherein the sensor suite includes at least one of a temperature sensor, moisture sensor, gyroscopic sensor, or soil sensor.

Variation 17 may include a system for monitoring and facilitating mattress care as in any of variations 9 through 16, wherein collecting collect mattress data via a sensor suite includes collect mattress data from a plurality of mattresses via a plurality of sensor suites, each sensor suite integrated into a respective individual mattress.

According to variation 18, a system for monitoring and facilitating mattress care may include at least one computing device in operable connection with a network; a memory that stores computer-executable components; a processor that executes the computer-executable components stored in the memory, wherein the computer-executable components include instructions for collecting first mattress data from a plurality of mattresses via a plurality of sensor suites, each sensor suite integrated into a respective individual mattress, the first mattress data including at least one of mattress orientation, temperature, soil level, or moisture level; reading mattress maintenance interval data from a database in operable communication with the at least one computing device; compare mattress data to mattress maintenance interval data to determine if mattress maintenance is required; communicating at least one notification to the at least one computing device that maintenance is required; displaying, on the at least one computing device, that maintenance is required; receiving user input via the at least one computing device that maintenance has been performed; collecting second mattress data from the plurality of mattresses via the plurality of sensor suites, the second mattress data including at least one of updated mattress orientation, updated temperature, updated soil level, or updated moisture level; determining that maintenance has been properly performed by comparing the second mattress data to the first mattress data and the mattress maintenance interval data; and communicating a notification to the at least one computing device that maintenance is in complete.

Variation 19 may include a system for monitoring and facilitating mattress care as in variation 18, further including communicating instructions on how to properly perform maintenance to the at least one computing device.

Variation 20 may include a system for monitoring and facilitating mattress care as in variations 18 or 19, further including displaying the instructions on how to properly perform maintenance on the at least one computing device.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for monitoring and facilitating mattress care, the system comprising:
at least one computing device in operable connection with a network;
a memory that stores computer-executable components;
a processor that executes the computer-executable components stored in the memory, wherein the computer-executable components comprise instructions for:
collecting mattress data via a sensor suite;
reading mattress maintenance interval data from a database in operable communication with the at least one computing device;
comparing mattress data to mattress maintenance interval data to determine if mattress maintenance is required;
communicating at least one notification to the at least one computing device that maintenance is required;
receiving user input via the at least one computing device that maintenance has been performed;
collecting mattress data via the sensor suite; and
determining that maintenance has been properly performed.

2. A system for monitoring and facilitating mattress care as in claim 1, wherein determining that maintenance has been properly performed comprises communicating a notification to the at least one computing device that maintenance is complete.

3. A system for monitoring and facilitating mattress care as in claim 1, wherein determining that maintenance has been properly performed comprises communicating a notification to the at least one computing device that maintenance is incomplete.

4. A system for monitoring and facilitating mattress care as in claim 3, further comprising communicating instructions on how to properly perform maintenance to the at least one computing device.

5. A system for monitoring and facilitating mattress care as in claim 4, further comprising displaying the instructions on how to properly perform maintenance on the at least one computing device.

6. A system for monitoring and facilitating mattress care as in claim 1, wherein the sensor suite is integrated into a mattress.

7. A system for monitoring and facilitating mattress care as in claim 1, wherein mattress data comprises at least one of mattress orientation, temperature, soil level, or moisture level.

8. A system for monitoring and facilitating mattress care as in claim 1, wherein the sensor suite comprises at least one of a temperature sensor, moisture sensor, gyroscopic sensor, or soil sensor.

9. A non-transitory computer-readable media maintaining instructions of a first instance of an application that, when executed by one or more processors of a first computing device, program the one or more processors to:
collect first mattress data via a sensor suite;
read mattress maintenance interval data from a database in operable communication with the at least one computing device;
compare mattress data to mattress maintenance interval data to determine if mattress maintenance is required;
communicate at least one notification to the at least one computing device that maintenance is required;
receive user input via the at least one computing device that maintenance has been performed;
collect second mattress data via the sensor suite; and
determine that maintenance has been properly performed by comparing the second mattress data to the first mattress data and the mattress maintenance interval data.

10. A system for monitoring and facilitating mattress care as in claim 9, wherein determining that maintenance has been properly performed comprises communicating a notification to the at least one computing device that maintenance is complete.

11. A system for monitoring and facilitating mattress care as in claim 9, wherein determining that maintenance has been properly performed comprises communicating a notification to the at least one computing device that maintenance is incomplete.

12. A system for monitoring and facilitating mattress care as in claim 11, further comprising communicating instructions on how to properly perform maintenance to the at least one computing device.

13. A system for monitoring and facilitating mattress care as in claim 12, further comprising displaying the instructions on how to properly perform maintenance on the at least one computing device.

14. A system for monitoring and facilitating mattress care as in claim 9, wherein the sensor suite is at least one of sewn, glued, or adhered to a mattress.

15. A system for monitoring and facilitating mattress care as in claim 9, wherein mattress data comprises at least one of mattress orientation, temperature, soil level, or moisture level.

16. A system for monitoring and facilitating mattress care as in claim 9, wherein the sensor suite comprises at least one of a temperature sensor, moisture sensor, gyroscopic sensor, or soil sensor.

17. A system for monitoring and facilitating mattress care as in claim 9, wherein collecting collect mattress data via a sensor suite comprises collect mattress data from a plurality of mattresses via a plurality of sensor suites, each sensor suite integrated into a respective individual mattress.

18. A system for monitoring and facilitating mattress care, the system comprising:
at least one computing device in operable connection with a network;
a memory that stores computer-executable components;
a processor that executes the computer-executable components stored in the memory, wherein the computer-executable components comprise instructions for:
collecting first mattress data from a plurality of mattresses via a plurality of sensor suites, each sensor suite integrated into a respective individual mattress, the first mattress data comprising at least one of mattress orientation, temperature, soil level, or moisture level;
reading mattress maintenance interval data from a database in operable communication with the at least one computing device;
compare mattress data to mattress maintenance interval data to determine if mattress maintenance is required;
communicating at least one notification to the at least one computing device that maintenance is required;
displaying, on the at least one computing device, that maintenance is required;
receiving user input via the at least one computing device that maintenance has been performed;
collecting second mattress data from the plurality of mattresses via the plurality of sensor suites, the second mattress data comprising at least one of updated mattress orientation, updated temperature, updated soil level, or updated moisture level;
determining that maintenance has been properly performed by comparing the second mattress data to the first mattress data and the mattress maintenance interval data; and
communicating a notification to the at least one computing device that maintenance is in complete.

19. A system for monitoring and facilitating mattress care as in claim 18, further comprising communicating instructions on how to properly perform maintenance to the at least one computing device.

20. A system for monitoring and facilitating mattress care as in claim 19, further comprising displaying the instructions on how to properly perform maintenance on the at least one computing device.
